(19) United States
(12) Patent Application Publication
(10) Pub. No.: US 2018/0042422 A1
(43) Pub. Date: Feb. 15, 2018

(54) Automatic French Press Device

(71) Applicant: Patricia Brennan, Virginia Beach, VA (US)

(72) Inventor: Patricia Brennan, Virginia Beach, VA (US)

(21) Appl. No.: 15/670,733

(22) Filed: Aug. 7, 2017

Related U.S. Application Data
(60) Provisional application No. 62/374,219, filed on Aug. 12, 2016.

(51) Int. Cl. A47J 31/20; A47J 31/44; A47J 31/06

(52) U.S. Cl. CPC A47J 31/20; A47J 31/06; A47J 31/44; A47J 31/00

(57) ABSTRACT

Disclosed is an automatic French press device having a coffee bean grinder, a water heating unit, and a dispenser for coffee grounds and hot water. The dispensers are disposed over a French press vessel so as to directly dispense the coffee grounds and hot water therein. The grinder unit, the water heating unit, and the dispenser are controlled via a control panel that can communicate with a user device via an application so as to allow the French press device to be operated remotely.

### CROSS REFERENCE TO RELATED PATENT APPLICATIONS

This application claims priority to U.S. Provisional Patent Application No. 62/374,219, filed Aug. 12, 2016, and entitled “Automatic French Press Device,” which is hereby incorporated by reference in its entirety.

### FIELD OF THE INVENTION

The present invention relates generally to a device for preparing a beverage. More particularly, the present invention is directed to a device for automatically preparing French press coffee.

### BACKGROUND OF THE INVENTION

French press is a popular way to brew strong coffee. There are several steps involved in making French press coffee. Generally, a user must measure the coffee beans, grind the coffee beans, heat the water to boiling, add hot water, stir the brew, steep the coffee, and plunge the press. Thus, a coffee bean grinder and a kettle are needed in addition to the French press vessel in order to brew the coffee. While some individuals enjoy this traditional method of making French press, this method can be an inconvenient and time-consuming process that requires human intervention.

Some devices in the prior art disclose automatic coffee makers that are configured to make drip coffee and espresso on a scheduled basis. These devices generally comprise a water tank with water heated to a predetermined temperature via a water heater, a coffee filter for holding coffee grounds, and a drip valve for dispensing brewed coffee therefrom. Hot water is poured over the coffee filter and filtered (e.g., via gravity, vacuum, pressure, etc.) through the drip valve. The drip valve is positioned over a carafe or a pot so that the coffee is directly poured into the carafe or the pot. In this regard, the prior art devices do not disclose a device for brewing French press coffee that is configured to brew coffee within a French press vessel, wherein the device can automatically dispense coffee grounds and hot water directly into the French press vessel. In this regard, the invention described herein addresses this problem.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

Disclosed herein is a device for automatic preparing French press coffee. In various embodiments, the device comprises a coffee bean grinder unit, a water heating unit, and one or more dispensers for coffee grounds and hot water, wherein the coffee bean grinder unit, the water heating unit, and the dispensers are operated via a control panel. The coffee bean grinder unit can be connected to a coffee bean container that stores whole coffee beans therein. The water heating unit can be connected to a water container that stores water therein. The control panel can comprise control buttons and/or a display screen that can comprise a touch screen for providing a user interface for receiving user input and outputting information. The dispensers are disposed over a French press vessel so as to directly dispense the coffee grounds and hot water therein.

In various embodiments, the device is configured to receive commands from a user in a remote location and operate via a mobile application installed on a smart phone or other handheld network-enabled electronic devices. The application provides an application user interface for controlling various settings of the French press device. For instance, the application user interface enables a user to schedule brew times, adjust the coarseness of coffee grounds, adjust the amount of coffee to brew, keep coffee warm for a predetermined amount of time, and/or so forth.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts a front view of the present invention.

FIG. 2 shows a view of the water tank being inserted into the French press.

FIG. 3 depicts a transparent view of the present invention.

FIG. 4 shows a block diagram of an exemplary embodiment of the present invention.

### DETAILED DESCRIPTION OF THE INVENTION

The present invention is directed towards an automatic French press device. For purposes of clarity, and not by way of limitation, illustrative views of the present French press device are described with references made to the above-identified figures. Various modifications obvious to one skilled in the art are deemed to be within the spirit and scope of the present invention.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form.

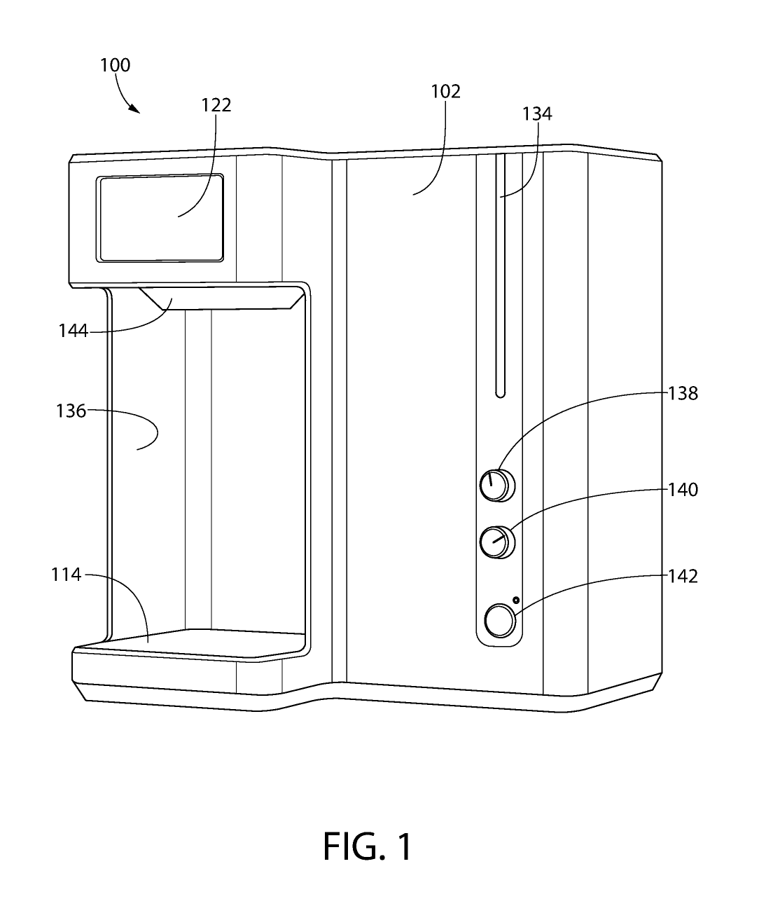

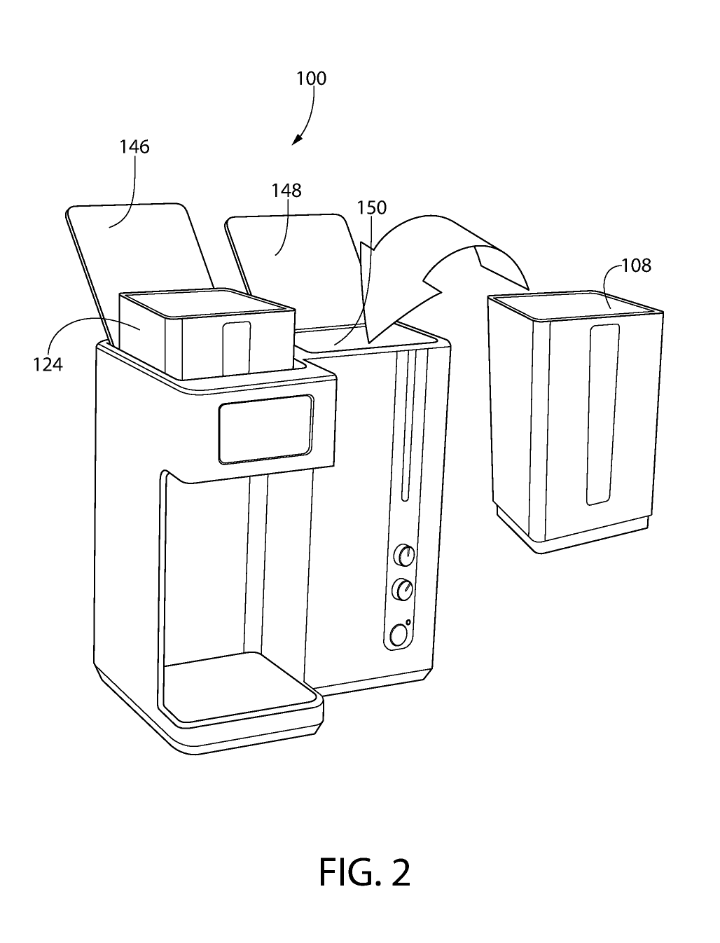

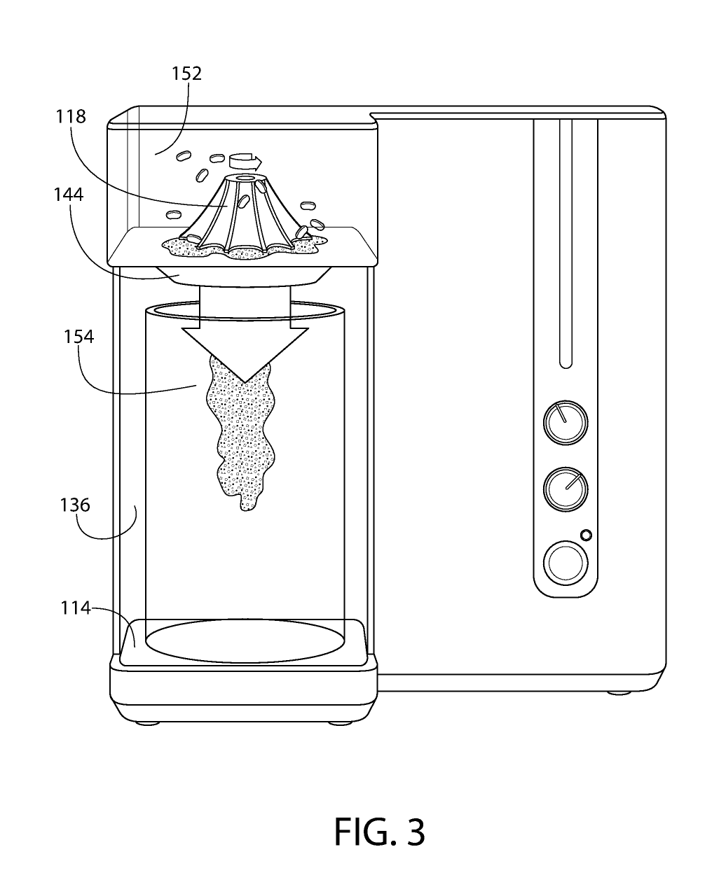

Referring now to FIGS. 1 through 3, there are shown various views of an exemplary embodiment of the present invention. The present invention comprises an automatic French press device 100 having a housing member 102 with a defined interior volume. The housing member 102 comprises a cavity 136 on a front portion thereof for at least partially receiving a French press vessel 154 therein. The cavity 136 comprises a base member 114 that is configured to support the French press vessel 154 thereon, wherein the base member 114 is removably attached or adjustable in height to accommodate vessels 154 of various height, size, and dimension. Additionally, the base member 114 can comprise a hot plate for heating the French press vessel 154 thereon.

The top of the cavity 136 comprises a dispensing unit 144 for dispensing coffee grounds and water into the French press vessel 154 positioned therebelow. In various embodiments, the dispensing unit 144 can comprise a single dispensing unit for dispensing both coffee grounds and water. Alternatively, the dispensing unit 144 can comprise separate dispensers for coffee grounds and water. For example, the dispensing unit 144 can comprise a first dispenser for dispensing coffee grounds and a second dispenser for dispensing water. Preferably, the first dispenser and the second dispenser are positioned such that water and coffee grounds can be dispensed directly into the French press vessel 154 when positioned within the cavity 136 of the housing member 102.

The dispensing unit 144 or the first dispenser is in fluid communication with the coffee bean grinder 118 positioned in the interior of the housing member 102. The coffee bean grinder 118 can be disposed within a coffee bean container 124 that is configured to hold whole coffee beans therein. The coffee bean container 124 is accessible via a lid 146 that is hingedly attached at the top of the housing member 102. The coffee bean container 124 can be removably positioned within the interior volume of the device 100.

The dispensing unit 144 or the second dispenser is further in fluid communication with a water container 108 via a water pump disposed in the interior of the housing member 102, wherein the water pump is configured to draw water from the water container 108 and expel the water through the dispensing unit 144. The water container 108 is accessible via a lid 148 that is hingedly attached at the top of the housing member 102. The water container 108 can be removably positioned within the interior volume of the device 100.

In various embodiments, the interior volume of the device 100 can comprise multiple interior compartments 150, 152 for separately maintaining the water container 108 and the coffee bean container 124 therein. In the illustrated embodiment, the water container 108 is in the first interior compartment 150 and the coffee bean container 124 is in the second interior compartment 152. The housing member 102 comprises a window 134 through which the level of water in the water container 108 is visible. The water container 108 can be operatively connected to a water heating unit disposed in the interior of the housing member 102, whereby the water heating unit is operably connected to a water temperature control module that comprises a thermometer for monitoring the temperature of the water in the water container 108.

The device 100 can be operated via a control panel that comprises a plurality of control buttons 138, 140, 142. In various embodiments, the device 100 can be also operated via a display screen 122 that can comprise a touch screen, wherein the touch screen can comprise a user interface with virtual buttons and/or keypad for inputting user commands. The control panel and/or the display screen 122 is operably connected to the coffee bean grinder 118, the water heating unit, and/or each the dispensing unit 144. For example, a user can operate the coffee bean grinder 118 by adjusting the coarseness of the coffee grounds and the amount of coffee to dispense using a first button 138. Additionally, a user can operate the water heating unit by adjusting the temperature of the water and the amount of water to dispense using a second button 140. Moreover, a user can power the device 100 on and off using a third button 142 that can comprise a power button

In operation, the first dispenser is configured to dispense the coffee grounds before the second dispenser dispenses hot water. In this way, hot water is poured over to help soak the ground coffee. Dispensing the coffee grounds before dispensing the hot water also prevents the coffee from floating atop the hot water. In various embodiments, the base member 114 is configured to rotate or gyrate as the hot water is dispensed from the second dispenser, thereby moving the French press vessel 154 slightly in order to help soak the coffee grounds. In this regard, the base member 114 can be operatively connected to a motor such as a vibrating motor that can move the base member 114 without causing the French press vessel 154 to tip or topple over. Alternatively, the second dispenser is configured to dispense hot water in a spiral configuration. More specifically, the second dispenser can be operatively connected to a motor such as a rotational motor such that as the second dispenser moves in a substantially rotational movement, the water dispenses in a spiral or a ring-like pattern. Once the coffee is steeped for a predetermined amount of time, the device 100 can emit an alarm for notifying the user to press the plunger of the French press vessel to the bottom of the vessel and consume the beverage.

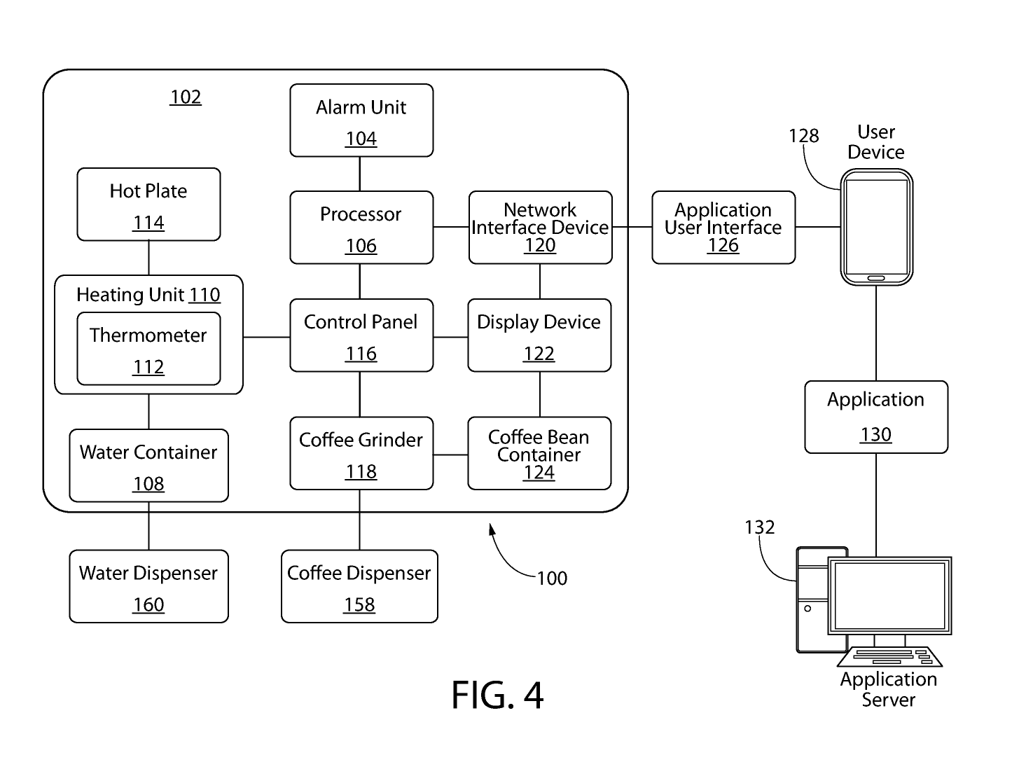

Referring now to FIG. 4, there is shown a block diagram of the exemplary embodiment of the invention. The housing member 102 of the French press device 100 comprises a processor 106 that is connected to an alarm unit 104, a network interface device 120, and a control panel 116. The processor 106 can comprise a machine-readable medium on which is stored one or more sets of data structures and instructions (e.g., software) embodying or utilized by any one or more of the methods or functions described herein. While the processor 106 is shown in an example embodiment to be a single medium, the term “machine-readable medium” may include a single medium or multiple media (e.g., a centralized or distributed database, and/or associated caches and servers) that store the one or more instructions or data structures.

The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media.

The control panel 116 comprises a user interface for receiving user input, displaying information, and/or so forth. In various embodiments, the control panel 116 comprises buttons 138, 140, 142 (FIG. 1), a display device 122 that can comprise a touch screen providing a user interface, and/or so forth. The control panel 116 is operably connected to the coffee bean grinder 118, the water heating unit 110, and the display device 122. A user can adjust the settings of the coffee grinder 118 by selecting the coarseness of the coffee grounds via the control panel 116. For instance, one or more buttons 138, 140, 142 (FIG. 1) can comprise a knob that can be rotated in a clockwise direction to increase the coarseness of the coffee grounds. Conversely, the knob can be rotated in a counter-clockwise direction to decrease the coarseness of the coffee grounds. In another example, the display device 122 can comprise a user interface that displays a menu from which the user can select the coarseness of the coffee grounds.

Additionally, the user can adjust the settings of the coffee grinder 118 by specifying or selecting the amount of coffee grounds to dispense depending on the amount of coffee to be brewed or the volume of the French press vessel (e.g., 4 cups, 6 cups, etc.) via the control panel 116. For instance, one or more buttons 138, 140, 142 (FIG. 1) can comprise a knob that can be rotated in a clockwise direction to increase the amount of coffee grounds to dispense. Conversely, the knob can be rotated in a counter-clockwise direction to decrease the amount of coffee grounds to dispense. The display device 122 can also provide a user interface for displaying a menu from which the user can select the amount of the coffee grounds to dispense. In various embodiments, the device 100 can automatically suggest and display on the display device 122 the coarseness of the coffee grounds and/or the amount of coffee grounds to dispense based at least partially on the user's selection for the strength of the coffee (e.g., light, medium, or dark coffee) and/or the amount of coffee to be brewed.

Similarly, the user can also adjust the settings of the water heating unit 110 by selecting the temperature of the water and/or the amount of water to dispense depending on the amount of coffee to be brewed or the volume of the French press vessel via the control panel 116. For instance, one or more buttons 138, 140, 142 (FIG. 1) can comprise a knob that can be rotated in a clockwise direction to increase the temperature of the water. Conversely, the knob can be rotated in a counter-clockwise direction to decrease the temperature of the water. The display device 122 can also provide a user interface for enabling the user to input the desired temperature, for example, via a virtual keypad on the display device 122. Additionally, one or more buttons 138, 140, 142 (FIG. 1) can comprise a knob that can be rotated in a clockwise direction to increase the amount of water to dispense. Conversely, the knob can be rotated in a counter-clockwise direction to decrease the amount of water to dispense. The display device 122 can also provide a user interface for enabling the user to input the desired amount or volume of water to dispense, for example, via a virtual keypad on the display device 122. In various embodiments, the device 100 can be preprogrammed such that it automatically suggests and displays on the display device 122 the temperature of the water and/or the amount of water to dispense based at least partially on the user's selection for the strength of the coffee (e.g., light, medium, or dark coffee) and/or the amount of coffee to be brewed.

In various embodiments, the user's settings can be saved automatically each time the settings are modified so as to allow the device 100 to dispense coffee grounds and water according to the last saved preferences. Alternatively, the device 100, via the processor 106, is configured to save a number of preference settings. For example, the device 100 can save preference settings for different user profiles. More specifically, the device can save a first set of preference settings for User A, and a second set of preference settings for User B. In this way, the device 100 can save preference settings for multiple users.

The water heating unit 110 can include a thermometer 112 or another type of sensor for detecting the temperature of the water in the water container 108 to allow the control panel 116 to automatically adjust the settings of the water heating unit 110. Thus, the heating unit 110 is connected to a water container 108. For example, if the thermometer 112 detects that the temperature of the water is lower than a targeted temperature or a temperature range as specified by the user's setting, the control panel 116 signals the heating unit 110 to raise the temperature of the water. Conversely, if the thermometer 112 detects that the temperature of the water is higher than the targeted temperature or the temperature range as specified by the user's setting, the control panel 116 signals the heating unit 110 to lower the temperature of the water. Additionally, the control panel 116 can signal heating unit 110 to adjust the temperature of the hot plate 114 on the base member of the device 100 to keep ground coffee and dispensed water in the French press vessel at the desired temperature until the coffee is brewed and consumed.

The water container 108 is connected to a water dispenser 160 via a water pump that is configured to draw water from the water container 108 and expel or force the water through the water dispenser 160. The water dispenser 160 can be a part of the dispensing unit 144 (FIG. 1) or a separate dispensing unit. The water container 108 can be removably inserted into the interior volume of the housing member 102 so that it can be readily refilled with water as needed. The coffee grinder 118 is connected to a coffee dispenser 158. The coffee dispenser 158 can be part of the dispensing unit 144 (FIG. 1) or a separate dispensing unit that can work in conjunction with the water dispenser 160. Preferably, the coffee grinder 118 is adjacent to the coffee dispenser 158 so as to allow ground coffee from the coffee grinder 118 to be easily expelled through the coffee dispenser 158. The coffee grinder 118 is operatively connected to a coffee bean container 124, which can be removably inserted into the interior volume of the housing member 102 so that it can be readily refilled with coffee beans as needed. In some embodiments, the coffee grinder 118 is integral to the coffee bean container 124 so that the coffee grinder 118 and the coffee bean container 124 operate as a single unit. Said another way, at least a portion of the coffee grinder 118 can be removable together with the coffee bean container 124 and then inserted into the interior volume of the housing member 102. In this way, the coffee grinder 118 can be cleaned and maintained with ease.

In various embodiments, the display device 122 can be connected to a network interface device 120 for providing a user interface from which the user can set network preference settings. For example, the user can set up Bluetooth™ connection, Wifi connection, and/or so forth. Additionally, the user can pair, via the network interface device 120, the device 100 with a network enabled user device 128, which includes a smart phone and other handheld electronic devices. It is contemplated that various methods can be used to pair the device 100 and the user device 128. For example, the network interface device 120 can generate a code to input into the user device 128 to correctly identify and connect the devices. The network interface device 120 may include wireless and/or wired communication components that enable the device 100 to transmit data to and to receive data from other networked devices such as the network enabled user device 128 and to connect to a network via Bluetooth™, Wifi, and/or so forth.

The user device 128 comprises a downloadable or non-downloadable application 130 accessible therefrom, further wherein the application 130 is supported by an application server 132. The application 130 can comprise a mobile application, a web application, a website, a plug-in, a browser extension, and/or so forth, depending upon embodiments. The application 130 provides an application user interface 126 that is accessible on the user device 128 for receiving user commands (e.g., user preference settings) and outputting or displaying information, such as alerts and notifications. In various embodiments, the application 130 enables the user device 128 to communicate with the control panel 116 of the device 100 in order to select water temperature, coarseness of coffee grounds, and the amount of water and/or coffee grounds to be dispensed depending upon the size of the French press vessel and the strength of the coffee brew that the user desires. Upon establishing a communication connection between the user device 128 and the device 100, the application 130, via the application user interface 126, enables a user to set the amount of coffee to brew, strength of the coffee (e.g., light, medium, dark), and adjust the settings of the coffee grinder 118 and the heating unit 110.

Additionally, the application 130, via the application user interface 126, is configured to enable the user to set a schedule so as to activate the device 100 automatically to brew coffee at a scheduled time. A user can save his or her preferences (e.g., water temperature, coarseness of coffee grounds, etc.) to facilitate the brewing process. In various embodiments, the application 130 can communicate with an alarm unit 104 that is integral to the device 100. The alarm unit 104 is configured to detect when the water container 108 has less than a predetermined amount or volume of water and/or when the coffee bean container 124 has less than a predetermined amount of coffee beans.

Additionally, the alarm unit 104 can provide notifications to the user via the application user interface 126. In this way, the alarm unit 104 can alert the user when the user needs to refill water or coffee beans, or other predetermined conditions are met (e.g., the device needs to be cleaned, water filters need to be replaced, coffee grinder needs to be cleaned, etc.). Moreover, the alarm unit 104 can provide notifications to the user via the application user interface 126 when the beverage is ready for consumption. In various embodiments, the alerts and/or notifications can be displayed on the user device 128. Additionally, alerts and/or notifications can sound from the user device 128. In this way, the alarm unit 104 is configured to transmit alerts and/or notifications to the user device 128 via the application user interface 126. Alternatively, the alarm unit 104 can emit a sound from the device 100 to notify that the beverage is ready for consumption. In this regard, it is contemplated that the device 100 includes a signal outputting device such as a speaker and an alarm unit 104 that comprises a timer for measuring the steep time, wherein the steep time is adjustable via the control panel 116 and/or the application 130 depending on the user's preference settings.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device for making French press coffee, comprising:
a housing member with a defined interior volume, the housing member comprising a control panel and a cavity for at least partially receiving a French press vessel therein;
the interior volume comprising a coffee bean grinder, a water heating unit, a network interface device;
the control panel configured to operate the coffee bean grinder and the water heating unit;
the coffee bean grinder in fluid communication with a coffee dispenser for dispensing coffee grounds into the French press vessel;
the water heating unit in fluid communication with a water dispenser for dispensing hot water into the French press vessel;
the coffee dispenser configured to dispense the coffee grounds before the water dispenser dispenses the hot water.

2. The device of claim 1, wherein the housing member further comprises a base member for supporting the French press vessel thereon, wherein the base member is positioned at a lower portion of the cavity and the base member is configured to move, thereby moving the French press vessel.

3. The device of claim 1, wherein the housing member further comprises a base member for supporting the French press vessel thereon, wherein said base member includes a hot plate.

4. The device of claim 1, wherein the water heating unit is operatively connected to a thermometer.

5. The device of claim 1, wherein the network interface device is configured to enable the device to establish a communication connection with a user device for operating the device from a remote location.

6. The device of claim 1, wherein the housing member further comprises an alarm unit for emitting alerts when one or more predetermined conditions are met.

7. The device of claim 1, wherein the housing member further comprises a water container connected to the water dispenser.

8. the device of claim 1, wherein the housing member further comprises a coffee bean container connected to the coffee bean grinder.

9. The device of claim 1, wherein the housing member further comprises a display screen that is connected to the control panel for receiving user input and outputting information.

10. A system for making French press coffee, comprising:
a device comprising a coffee bean grinder, a water heating unit, a dispensing unit, and a network interface device;
a control panel for operating the coffee bean grinder, the water heating unit, and the dispensing unit;
the coffee bean grinder and the water heating unit connected to the dispensing unit for dispensing ground coffee and hot water into a French press vessel;
the network interface device configured to establish a communication connection between the device and a user device comprising an application installed thereon;
the application configured to control the coffee bean grinder, the water heating unit, and the dispensing unit from a remote location.

11. The system of claim 10, wherein the device further comprises a cavity for at least partially receiving the French press therein.

12. The system of claim 11, wherein the cavity comprises a base member for supporting the French press vessel thereon, further wherein the base member is configured to move, thereby moving the French press vessel therewith.

13. The system of claim 11, wherein the cavity comprises a base member for supporting the French press vessel thereon, further wherein the base member includes a hot plate.

14. The system of claim 10, wherein the water heating unit is operatively connected to a thermometer.

15. The system of claim 10, wherein the device further comprises an alarm unit for emitting alerts when one or more predetermined conditions are met.

16. The system of claim 10, wherein the application provides an application user interface for configuring user preferences, further wherein the user preferences comprise water temperature, coarseness of coffee grounds, and brew time.

17. The system of claim 15, wherein the application provides an application user interface for displaying alerts and notifications received from the alarm unit.

18. The system of claim 10, wherein the device further comprises a water container connected to the water dispenser.

19. The system of claim 10, wherein the device further comprises a coffee bean container connected to the coffee bean grinder

20. The system of claim 10, wherein the device further comprises a display screen that is connected to the control panel for receiving user input and outputting information.
